(19) United States
(12) Patent Application Publication
(10) Pub. No.: US 2007/0001110 A1
(43) Pub. Date: Jan. 4, 2007

(54) Optical scanning device

(75) Inventors: Erwin Rinaldo Meinders, Eindhoven (NL); Martinus Bernardus Van der Mark, Eindhoven (NL); Alexander Padiy, Eindhoven (NL); Johannes Theodorus Adriaan Wilderbeek, Eindhoven (NL); Josephus Arnoldus Henricus Maria Kahlman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,717

(22) PCT Filed: Jun. 3, 2004
(86) PCT No.: PCT/IB04/01847

§ 371 Date: Nov. 29, 2005

(30) Foreign Application Priority Data
Jun. 11, 2003 (EP) 03300026.6

(51) Int. Cl. H01J 40/14

(52) U.S. Cl. 250/234

(57) ABSTRACT

The invention relates to an optical scanning device for scanning an information carrier comprising a plurality of information layers which optical properties depend on a potential difference applied between two electrodes. The optical scanning device comprises a fixed part comprising means (302) for generating a signal comprising information about a selected information layer, and a rotating part comprising means (301) for receiving the information carrier. The receiving means comprise a plurality of contacts (311-318) for connecting the electrodes, means (303) for detecting the signal, means (304) for decoding the signal and means (304) for applying a potential difference between the contacts connected to the electrodes corresponding to the selected information layer.

### FIELD OF THE INVENTION

The present invention relates to an optical scanning device for scanning a multi-layer information carrier.

The present invention is particularly relevant for optical data storage and optical disc apparatuses for reading and/or recording data from and/or on multi-layer optical discs.

### BACKGROUND OF THE INVENTION

Conventional optical scanning devices usually comprise a damper on which a disc, such as a DVD (DVD stands for Digital Versatile Disc) is fixed before scanning. The optical scanning device comprises a spinning motor in order to rotate the damper and the information carrier. The rotating information carrier is scanned by an optical beam, in order to read information written in spirally shaped tracks, or to write information in spirally shaped grooves.

European patent applications 03290470.8, 03290471.6 and 03290473.2, filed on February 2003, the 27th, are dedicated to information carriers comprising a plurality of information layers which optical properties depend on a potential difference applied between two electrodes. Such information carriers can have a relatively large number of information layers. Actually, by appropriately selecting the potential differences applied to the information layers, one information layer of the information carrier can have optical properties suitable for scanning this information layer by means of an optical beam having a wavelength, whereas the other information layers can be transparent at the wavelength of the optical beam, thus not perturbing the scanning of the scanned information layer. In these patent applications, ROM, WORM and RW information carriers are described (ROM stands for Read Only Memory, WORM for Write Once Read Many and RW for ReWritable). Hence, the expression “scanning” means either reading or writing data from or to the information carrier.

An example of such an information carrier is described in FIGS. 1a and 1b, and corresponds to an information carrier described in European patent application 03290470.8.

Such an information carrier comprises a first information layer 11, a first electrolyte layer 12, a first counter electrode 13, a spacer layer 14, a second information layer 15, a second electrolyte layer 16 and a second counter electrode 17. Such an information carrier might comprise more than two information layers. For example, such an information carrier might comprise 10, 20 or up to 100 or more information layers. For example, an information carrier comprising 6 information layers is depicted in FIG. 1b. Such an information carrier might comprise information layers which optical properties cannot be changed by means of a potential difference. For example, the information carrier can comprise a ROM, a WORM or a RW information layer with non-switchable optical properties, said information layer being used as last information layer in the information carrier. This is particularly useful in an information carrier implementing the BD standard (BD stands for Blu-Ray Disc).

The information layers 11 and 15 comprise pits and lands, which are obtained by means of conventional techniques, such as embossing and printing.

This information carrier is intended to be scanned by an optical beam, which has a wavelength l. The first and second electrolyte layers 12 and 16, the first and second counter electrodes 13 and 17 as well as the spacer layer 14, are chosen to be transparent at the wavelength l, or at least to have a very small absorption at this wavelength, in order not to interact with the optical beam.

In the example of FIGS. 1a and 1b, the first and second information layers 11 and 15 comprise an electrochromic material. Other information carriers are described in the abovementioned patent applications, such as information carriers with information layers comprising liquid crystal materials.

An electrochromic material is a material having optical properties, which can change as a result of electron uptake or loss. Electrochromic materials are known from those skilled in the art. For example, the publication “Electrochromism: Fundamentals and Applications”, written by Paul M. S. Monk et. al. and published in 1995, describes the properties of electrochromic materials. Preferably, the electrochromic materials used in such an information carrier are thiophene derivatives, such as poly(3,4-ethylenedioxythiophene), also called PEDT or PEDOT and described, for example, in “Poly(3,4-ethylenedioxythiophene) and Its Derivatives: Past, Present and Future”, by L. Bert Goenendaal et. al., published in Advanced Materials 2000, 12, No. 7.

In the example of FIG. 1a, the electrochromic material of the first and second information layers 11 and 15 is the same, and has a reduced state and an oxidized state. The electrochromic material is chosen to have a high absorption and reflection at the wavelength l when it is in its reduced state, and a low absorption and reflection at the wavelength l when it is in its oxidized state.

When the first information layer 11 is scanned for reading information from this first information layer 11, a potential difference V1 is applied between the first information layer 11 and the first counter electrode 13, the first information layer 11 being at a higher potential than the first counter electrode 13. A current flows from the first information layer 11 to the first counter electrode 13, whereas electrons are transported from the first counter electrode 13 to the first information layer 11. Electrons are absorbed by the electrochromic materials, which becomes reduced. For reasons of electrical neutrality, positive ions from the first electrolyte layer 12 are absorbed by the first information layer 11 or negative ions are expelled by the first information layer 11, and negative ions from the first electrolyte 12 are absorbed by the first counter electrode 13 or positive ions are expelled by the first counter electrode 13. Hence, the first counter electrode is an ion-accepting and donating electrode. The potential difference V1 is chosen so that, when applied, the absorption and reflection of the first information layer 11 becomes relatively high at the wavelength l.

Then, once the absorption and reflection of the first information layer 11 is high, information can be read from this information layer using conventional read-out techniques, such as the phase difference read-out principle used, for example, for read-out of CD-ROM, or alternatively by the reflection or absorption difference between marks and non-marks.

Once the information of the first information layer 11 has been read, the second information layer 15 is scanned. First, the first information layer 11 is made transparent by applying a potential difference −V1 between the first information layer 11 and the first counter electrode 13, which is a reverse potential difference compared to V1. As a consequence, the electrochromic material of the first information layer 11 becomes oxidized, in which state it has a low absorption and reflection at the wavelength l. Then, the second information layer 15 is made absorbent, by applying a potential difference V2 between the second information layer 15 and the second counter electrode 17. In this example, V2 is equal to V1, because the first and second information stacks comprise the same electrochromic material.

Once the absorption of the second information layer 15 is high, information can be read from this information layer. The first information layer 11 does not perturb read-out of information, because the first information layer 11 is made transparent. As a consequence, it is possible to address only one information layer, while the rest of the information carrier is transparent or has a low absorption and reflection. The desired layer is addressed by applying the suitable potential differences between the information layers and the counter electrodes of the different information stacks.

The information layers thus have optical properties, which depend on a potential difference applied between two electrodes. In the case of FIGS. 1a and 1b, the two electrodes are the information layer and the counter electrode. In other cases, an information layer can be placed between two electrodes.

As a consequence, potential differences have to be applied to such an information carrier. This is not possible with a conventional optical scanning device in which the information carrier rotates during scanning.

### SUMMARY OF THE INVENTION

It is an object of the invention to provide an optical scanning device which is able to scan an information carrier comprising a plurality of information layers which optical properties depend on a potential difference applied between two electrodes.

To this end, the invention proposes an optical scanning device for scanning an information carrier comprising a plurality of information layers which optical properties depend on a potential difference applied between two electrodes, said optical scanning device comprising a fixed part comprising means for generating a signal comprising information about a selected information layer, and a rotating part comprising means for receiving said information carrier, said receiving means comprising a plurality of contacts for connecting said electrodes, means for detecting said signal, means for decoding said signal and means for applying a potential difference between the contacts connected to the electrodes corresponding to the selected information layer.

According to the invention, the information carrier is fixed to the rotating part. The rotating part comprises a plurality of contacts to which the electrodes are connected. As the rotating part and the information carrier rotate during scanning, it is not possible to apply potential differences to the information layers by means of wires connected to the fixed parts of the optical scanning device. As a consequence, the rotating part comprises the means for applying potential differences. When an information layer is selected by the optical scanning device, in order to change its optical properties, generating means are used to generate a signal comprising information about the selected information layer, which generating means are not mounted in the rotating part. A circuit in the fixed part can control the generating means in order to generate this signal. The rotating part comprises means for detecting said signal. Once the signal has been detected, it is decoded in the rotating part and the information about the selected information layer is sent to applying means, which apply a potential difference between the contacts connected to the electrodes corresponding to the selected information layer. As a consequence, no wire is used between the fixed part of the optical scanning device and the information carrier, which allows the information carrier to rotate freely.

Preferably, the means for applying a potential difference comprise a battery. This allows applying a potential difference to an information layer continuously, and thus changing its optical properties relatively rapidly.

Advantageously, the optical scanning device comprises an induction coil mounted on the rotating part and means for applying a magnetic flux through said induction coil in order to create an inductive current, the means for applying a potential difference being adapted to apply a potential difference corresponding to said inductive current between said two contacts. In this case, an induction coil mounted on the rotating part provides the energy necessary to apply potential differences. Hence, no battery is needed in the rotating part, as its rotation is converted into a current by means of the induction coil. Alternatively, a battery is used in the rotating part, and the induction coil is used in order to recharge said battery.

In a first embodiment of the invention, the generating means are a radiation source and the detecting means comprise a photosensitive detector. Preferably, the radiation source is a radiation source which is used for scanning the information carrier. In this case, the same radiation source is used in order to scan the information carrier and send information about the selected information layer. This simplifies the optical scanning device, as only one radiation source is required.

In a second embodiment of the invention, the detecting means comprise a conductive ring and the generating means comprise a brush adapted to transfer said signal to said conductive ring. According to this embodiment, an electrical contact is used in order to transfer the signal between the fixed part and the rotating part. This can be realized by means of a slip contact. Preferably, the conductive ring comprises a conductive fluid. Such a conductive fluid can easily rotate with the rotating part, while being in contact with a fixed brush or electrode.

In a third embodiment of the invention, the detecting means comprise a first conductor and the generating means comprise a second conductor adapted to transfer said signal to said first conductor by means of capacitive coupling.

In a fourth embodiment of the invention, the detecting means comprise an induction coil and the generating means comprise electromagnetic means adapted to create an inductive current inside said coil, said inductive current corresponding to said signal.

The invention also relates to a method for changing optical properties of a selected information layer in an information carrier comprising a plurality of information layers which optical properties depend on a potential difference applied between two electrodes, said method comprising the steps of generating a signal comprising information about the selected information layer, detecting and decoding said signal, and applying a potential difference between the electrodes corresponding to the selected information layer.

These and other aspects of the invention will be apparent from and will be elucidated with reference to the embodiments described hereinafter.

### BRIEF DESCRIPTION OF THE DRAWINGS The invention will now be described in more detail by way of example with reference to the accompanying drawings, in which:

FIGS. 1a and 1b show an information carrier for use with an optical scanning device in accordance with the invention;

FIG. 2 shows a rotating part and an information carrier in accordance with the invention;

FIG. 3 shows an optical scanning device in accordance with the invention;

FIG. 4 is a block diagram showing a functioning of the optical scanning device of FIG. 3;

FIG. 5 shows an optical scanning device in accordance with an advantageous embodiment of the invention;

FIG. 6a shows an optical scanning device in accordance with a first embodiment of the invention and FIG. 6b is a projection from a viewpoint P FIG. 6a;

FIG. 7 shows a preferred embodiment of the optical scanning device of FIG. 6a;

FIG. 8a shows a first optical scanning device in accordance with a second embodiment of the invention and FIG. 8b is a projection from a viewpoint P of FIG. 8a;

FIG. 9a shows a second optical scanning device in accordance with a second embodiment of the invention and FIG. 9b is a projection from a viewpoint P of FIG. 9a;

FIG. 10 shows a preferred embodiment of the optical scanning device of FIGS. 8a and 8b;

FIG. 11a shows an optical scanning device in accordance with a third embodiment of the invention and FIG. 11b is a projection from a viewpoint P of FIG. 11a;

FIG. 12 shows an optical scanning device in accordance with a fourth embodiment of the invention.

### DETAILED DESCRIPTION OF THE INVENTION

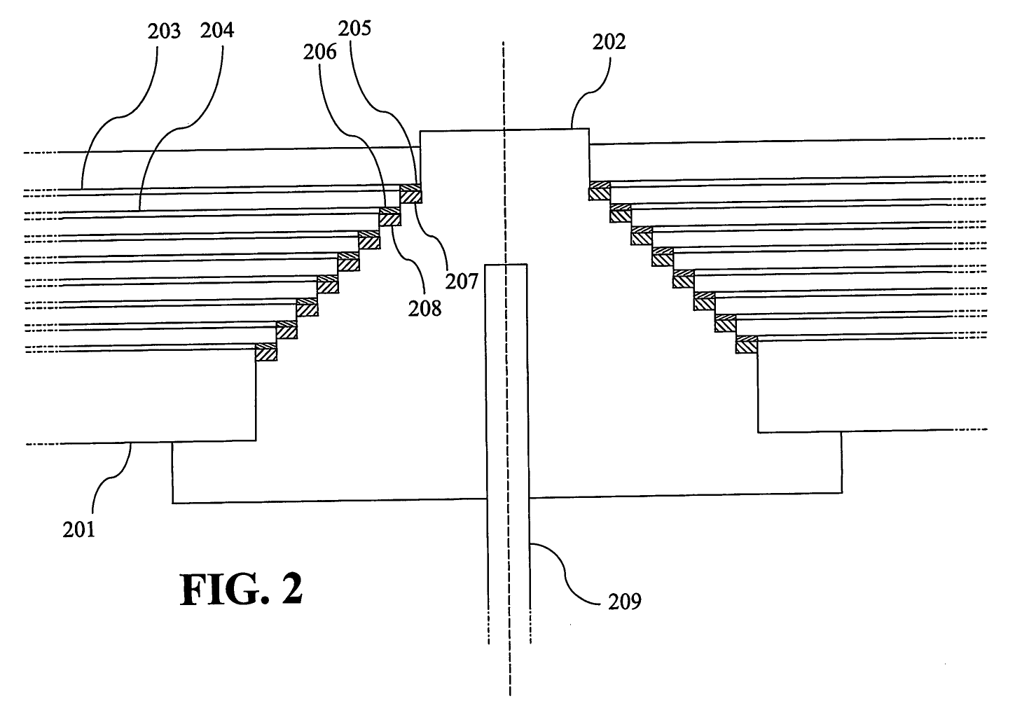

A rotating part and an information carrier in accordance with the invention are depicted in FIG. 2. A damper 202 is adapted to fixedly receive an information carrier 201. The damper 202 is mounted on a rotation axis 209, which is connected to a spinning motor, not shown on FIG. 2. The damper 202 and the rotation axis 209 form the rotating part.

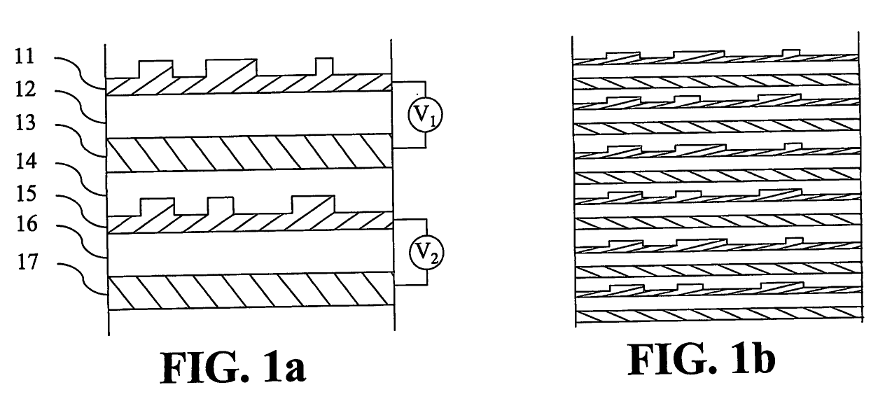

The information carrier 201 comprises a plurality of electrodes, such as electrodes 203 and 204. The information carrier 201 comprises a plurality of information layers, which optical properties depend on a potential difference applied between two electrodes. In the example of FIG. 2, only a part of the information carrier 201 is represented, which corresponds to an inner part of said information carrier 201. An information layer can be an electrode, as described in FIG. 1, or an information layer can be located between two electrodes.

The damper comprises contacts, such as contacts 207 and 208, which are adapted to connect the electrodes of the information carrier 201. In this example, a first electrode 203 comprises a first connection 205, which is connected to a first contact 207, and a second electrode 204 comprises a second connection 206, which is connected to a second contact 208.

The contacts of the damper 202 are connected to means for applying potential differences between two contacts, which applying means are comprised in the rotating part, as will be described in more details in the following Figures.

In the example of FIG. 2, the damper 202 has a staircase shape, which allows connecting the electrodes to the contacts of the clamper. Other shapes of the damper 202 can be provided, such as a damper having a ring shaped surface with contacts arranged in a circle on this surface. In this case, the information carrier has connections arranged in a circle on one of its surfaces in the inner region of the information carrier, which connections are connected to the electrodes of the information carrier. In the following, the invention is described in relation with a damper such as the damper described in FIG. 2. Of course, the invention applies to any clamper, as soon as the damper comprises contacts to which the electrodes of an information carrier can be connected.

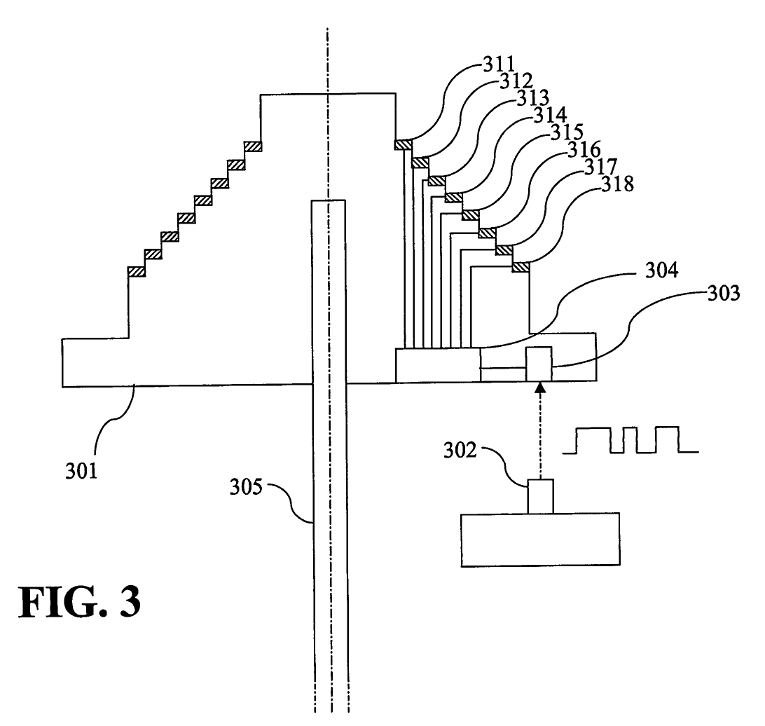

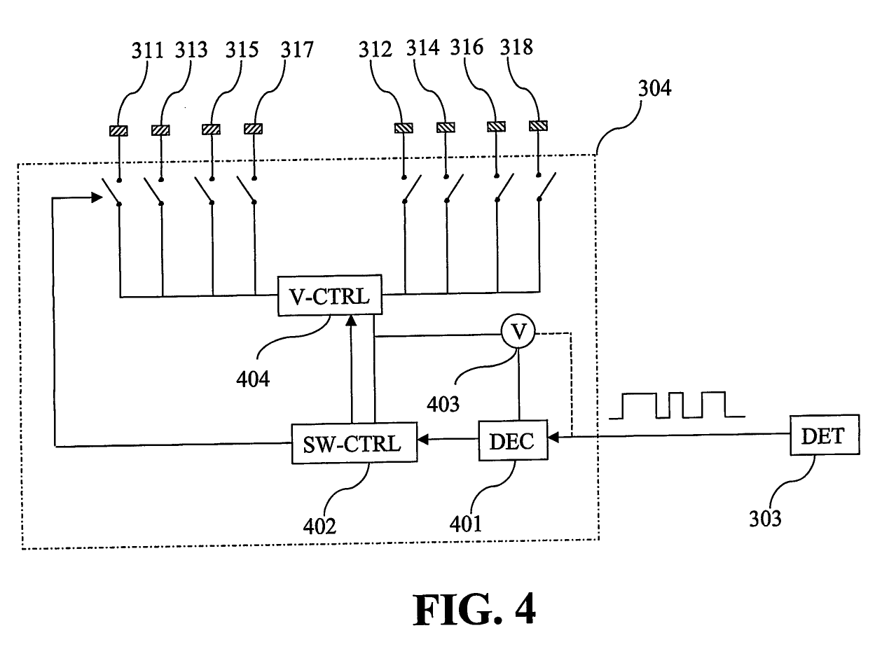

An optical scanning device in accordance with the invention is depicted in FIG. 3. This optical scanning device comprises a damper 301 and generating means 302. The damper 301 is mounted on a rotation axis 305, which is connected to a spinning motor. The damper 301 and the rotation axis 305 form a rotating part. The generating means 302 are fixed in the optical scanning device. The damper 301 comprises eight contacts 311 to 318. The damper 301 further comprises detecting means 303 and addressing means 304. The addressing means 304 comprise decoding means and applying means, as will be described in details in FIG. 4.

The generating means 302 are adapted to generate a signal comprising information about a selected information layer, which optical properties have to be changed. For example, an identifier of the selected information layer is encoded in this signal. Instead of an identifier of the selected information layer, the signal can comprise identifiers of the contacts between which a potential difference has to be applied. This is equivalent, as an identifier of the selected information layer can be deduced from identifiers of the contacts between which a potential difference has to be applied. The signal might comprise further information, such as an amplitude of a potential difference that has to be applied between two contacts in order to change the optical properties of the selected information layer.

This signal is, for example, a modulated signal, which is modulated as a function of the information about the selected information layer. Various types of modulation can be used, such as pulse modulation, analogue or digital frequency modulation, amplitude modulation or phase modulation.

The detecting means 303 are adapted to detect the signal generated by the generating means 302. The detected signal is provided to the addressing means 304, which are adapted to apply a potential difference between two contacts in order to change the optical properties of the information layer corresponding to the information comprised in the signal.

The addressing means 304 are depicted in details in FIG. 4. The addressing means 304 comprise decoding means 401, switch controlling means 402, an energy source 403 and voltage controlling means 404. The addressing means 304 further comprise switches, each switch corresponding to a given contact 311 to 318. The switch controlling means 402, the energy source 403, the voltage controlling means 404 and the switches form applying means. The decoding means 401, the switch controlling means 402 and the voltage controlling means 404 are powered by the energy source 403.

The signal generated by the generating means 302 is detected by the detecting means 303. The detected signal is then decoded by the decoding means 401, which then provides an identifier corresponding to the selected information layer. The decoding means 401 might provide further information, such as an amplitude of the potential difference, which has to be applied between two contacts. On the basis of this identifier, the switch controlling means 402 control the switches, so that a potential difference is applied between the contacts corresponding to the selected information layer. For example, if we assume that the selected information layer is an information layer located between the electrodes connected to contacts 311 and 312, the switch controlling means 402 switch the corresponding switches on. A potential difference is then applied between contacts 311 and 312, so that the optical properties of the corresponding information layer are changed.

The potential difference applied between two contacts is controlled by the voltage controlling means 404. Actually, in certain information carriers with a plurality of information layers which optical properties depend on a potential difference applied between two electrodes, different potential differences have to be applied, depending on the desired change of optical properties. For example, it might be necessary to apply a positive potential difference to an information layer in order to make it absorbent and reflective, and a negative potential difference in order to make it transparent.

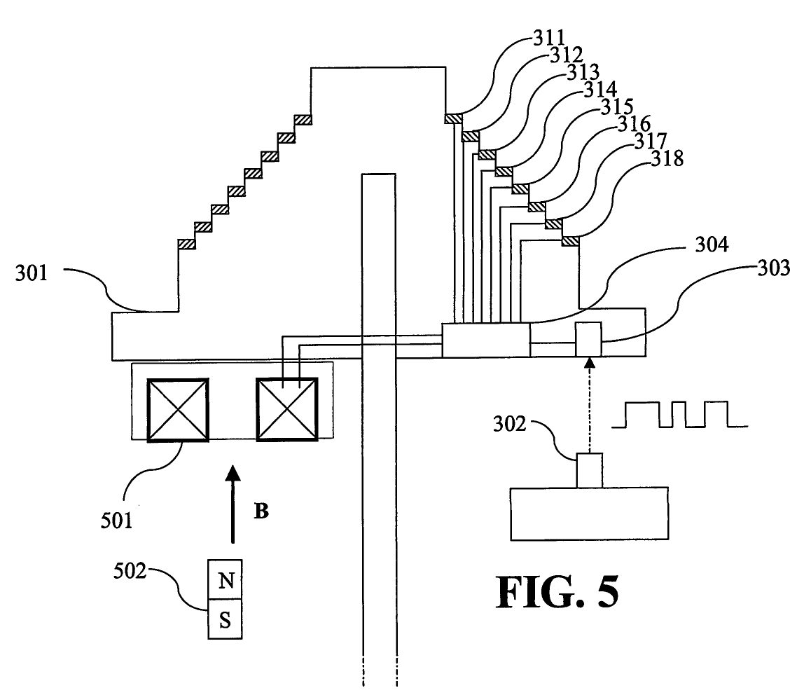

The energy source 403 can be a battery. This battery might be rechargeable, for example by means of a photodiode illuminated by the radiation source used for scanning the information carrier, or by any other light source such as an additional LED (LED stands for Light Emitting Diode), or by means of an induction coil mounted on the rotating part, as depicted in FIG. 5. A battery is particularly advantageous, because it allows applying a continuous potential difference between the contacts corresponding to the selected information layer. As a consequence, a relatively rapid change of the optical properties of the selected information layer is obtained.

Alternatively, the applying means can be adapted to apply a potential difference corresponding to the detected signal between the contacts. In this case, the energy source 403 is a power converter, such as a rectifier. A part of the detected signal is decoded by the decoding means 401, another part is sent to the energy source 403, which converts this signal into power.

The energy source 403 might also be a combination of a rechargeable battery and a power converter. In this case, a part of the detected signal is converted into power, which is used for recharging the battery.

FIG. 5 shows a rotating part in accordance with the invention, with an induction coil mounted on the rotating part. The damper 301 comprises an induction coil 501 mounted on it. The optical scanning device further comprises a fixed magnet 502, which creates a magnetic field B. During scanning of the information carrier, the damper 301 rotates. As a consequence, the magnetic flux created by the magnetic field inside the induction coil 501 varies, so that an inductive current is created in the induction coil 501. This inductive current is used by the addressing means 304, which supplies said inductive current between the two contacts corresponding to the selected information layer. In this case, no battery is needed. Alternatively, a battery can be used in the rotating part, and the inductive current is then used in order to recharge said battery.

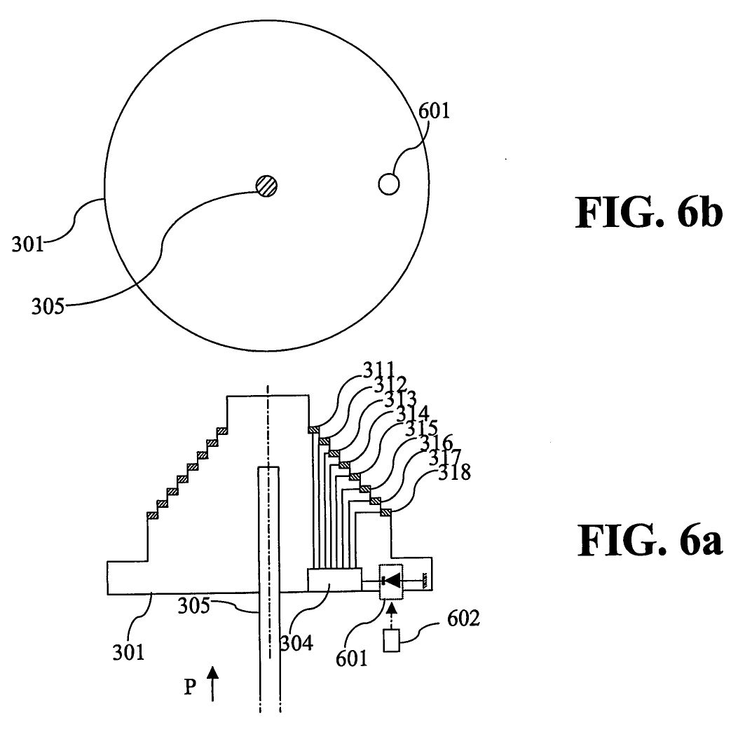

FIG. 6a shows an optical scanning device in accordance with a first embodiment of the invention. In this embodiment, the generating means are a radiation source 602 and the detecting means comprise a photosensitive detector 601. The radiation source 602 is, for example, a laser or a LED. The radiation source 602 generates a radiation comprising information about a selected information layer, for example a pulse modulated radiation. The photosensitive detector 601 detects this radiation and sends a signal corresponding to this radiation to the addressing means 304. FIG. 6b is a projection from a viewpoint P of FIG. 6a.

In the example of FIG. 6a and 6b, the photosensitive detector 601 is not permanently illuminated by the radiation source 602. Actually, the photosensitive detector 601 has a certain area, and is located on the damper 301, so that it rotates with the damper 301 during scanning of the information carrier fixedly mounted on the damper 301. If it is assumed that the photosensitive detector 601 has a diameter of 1 millimetre, it is then illuminated during about 0.1 milliseconds per rotation of the damper 301, if the damper 301 rotates with a linear velocity of 10 meter per second, which corresponds to the linear velocities usually used in the conventional optical scanning devices, such as a CD (Compact Disc), a DVD or a BD (Blu-Ray Disc) player. During this time of 0.1 milliseconds, the photosensitive detector 601 has to receive the information about the selected information layer. If the information carrier comprises 100 information layers, less than 100 pulses are necessary to encode the information about these information layers. Hence, pulses of microseconds length can be used. This can easily be achieved with a conventional LED or laser used as radiation source 602.

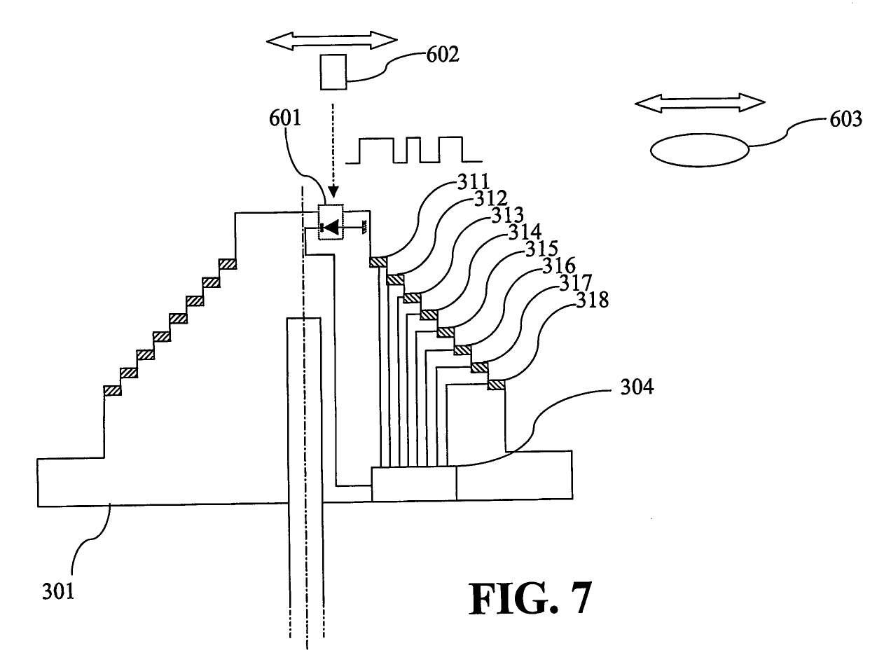

FIG. 7 shows an optical scanning device in accordance with a first embodiment of the invention, wherein the radiation source 602 is a radiation source which is used for scanning the information carrier. The optical scanning device comprises a laser source 602 and an objective lens 603. The laser source 602 produces an optical beam, which is then focussed on a scanned information layer, by means of the objective lens 603. In this embodiment, the laser source 602 is also used for generating a radiation comprising information about the selected information layer. Actually, the laser source 602 is a part of an optical pick-up unit, which is translatable relatively to the information carrier. The optical beam is used to encode information about to the information layer to be selected The laser source 602 generates for example a modulated optical beam. Once the photosensitive detector 601 has detected the modulated optical beam, the laser source 602 is translated in order to scan the information carrier.

In this embodiment, the generating means are translatable relatively to the information carrier. However, when the generating means generate the signal comprising the information about the selected information layer, they remain in a fixed position. As a consequence, the expression “fixed part” should not be understood as a part that is completely fixed, but as a part that can be fixed while the rotating part rotates, i.e. a part that does not rotate with the rotating part.

The modulated optical beam might be focussed on the photosensitive detector 601, by means of the objective lens 603, or by means of an additional lens. It is also possible to send the modulated optical beam as such to the photosensitive detector 601. In case of a pulse modulation, pulses of microseconds length can be used, as described hereinbefore. Such pulses can easily be achieved with conventional laser sources used in conventional optical scanning devices.

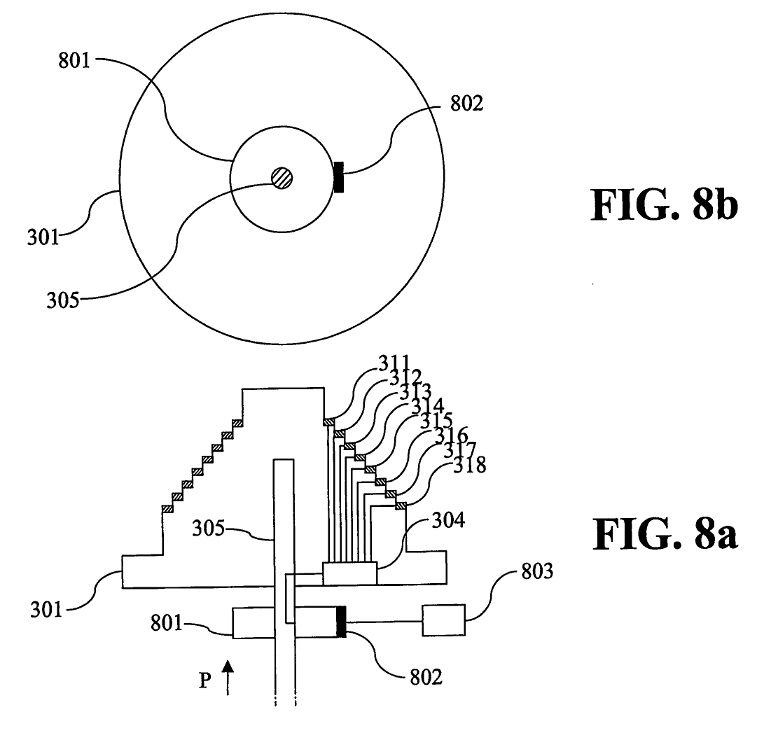

FIG. 8a shows a first optical scanning device in accordance with a second embodiment of the invention. Such an optical scanning device comprises a conductive ring 801, a brush 802 and a generator 803. The generator 803 and the brush 802 form generating means. FIG. 8b is a projection from a viewpoint P of FIG. 8a.

The generator 803 generates a signal comprising information about a selected information layer. This signal is transmitted to the brush 802, which is in electrical contact with the conductive ring 801. The signal is thus detected by the conductive ring 801, and then transmitted to the addressing means 304, which functioning has been described in FIG. 4.

The brush 802 is for example a carbon brush. The conductive ring 801 and the carbon brush 802 form a slip contact. Such a slip contact is described, for example, in patent U.S. Pat. No. 4,398,113, granted Aug. 9, 1983. Instead of a brush, another conductive ring can be used, which is fixed relatively to the conductive ring 801, and which is in electrical contact with the conductive ring 801. In order to achieve this, a ball bearing can be used between the two conductive rings. The ball bearing is lubricated by a conductive oil or grease which may contain electrically conductive particles such as carbon particles or metal particles or a conductive polymer.

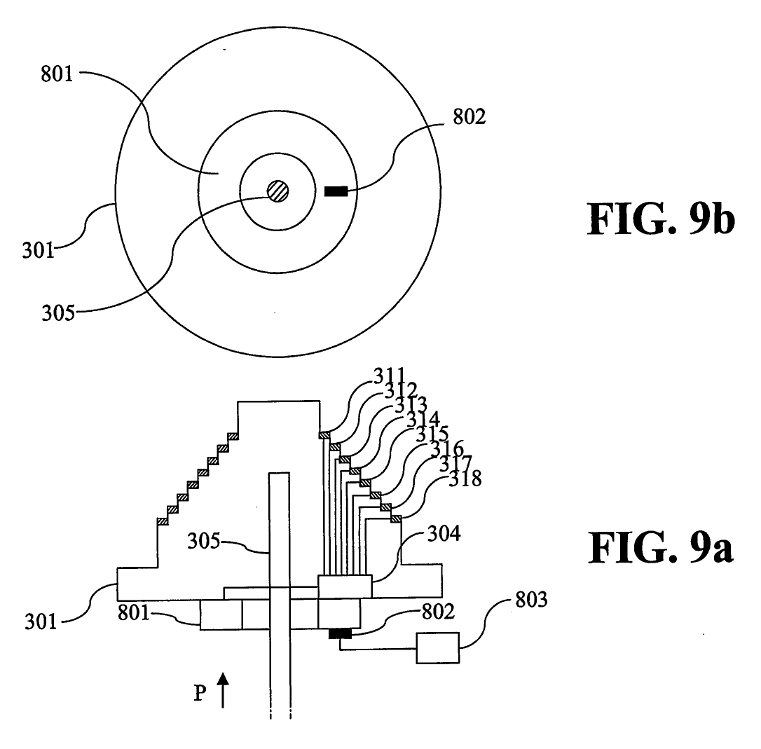

FIG. 9a shows a second optical scanning device in accordance with a second embodiment of the invention and FIG. 9b is a projection from a viewpoint P of FIG. 9a. This optical scanning device comprises the same elements as the optical scanning device depicted in FIGS. 8a and 8b, but the conductive ring 801 is mounted on the damper 301, instead of the rotation axis 305. The functioning of such an optical scanning device is the same as the functioning described in FIGS. 8a and 8b.

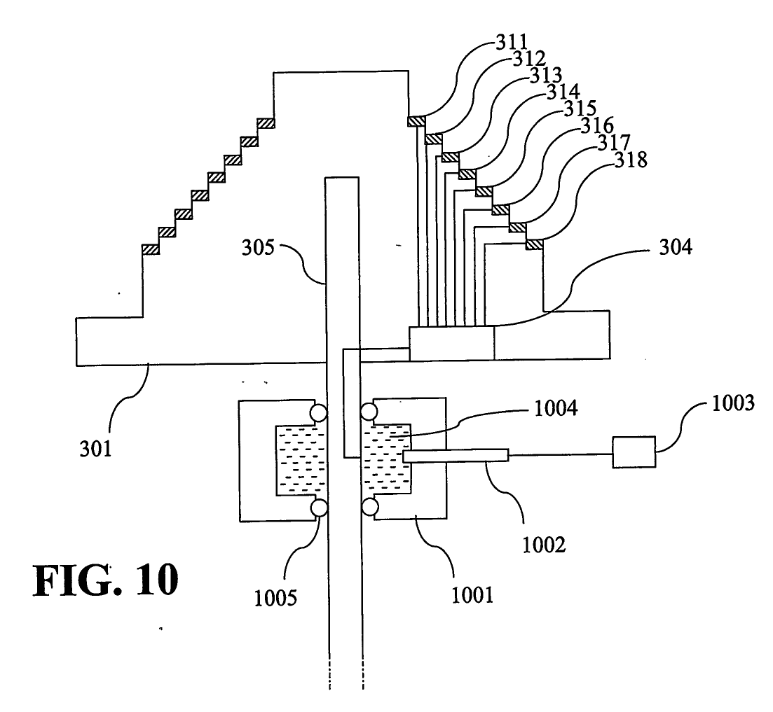

FIG. 10 shows a preferred embodiment of an optical scanning device according to the second embodiment of the invention. In this preferred embodiment, the conductive ring is made of a conductive fluid 1004. The conductive fluid is encapsulated in an isolated part 1001, which is fixed in the optical scanning device. Sealing rings 1005 are used to contain the conductive fluid 1004 in order to allow the rotation axis 305 to rotate relatively to the isolated part 1001.

An electrode 1002 is plunged into the conductive fluid 1004, and is connected to a generator 1003, which generates a signal comprising information about a selected information layer. This signal is then transmitted through the conductive fluid to the addressing means 304, which functioning has been described in FIG. 4. The conductive fluid 1004 can be a conducting fluid, or a suspension of a fluid carrier with metallic particles or carbon particles. For example, a polymeric matrix with copper particles embedded in the matrix can be used as conductive fluid 1004.

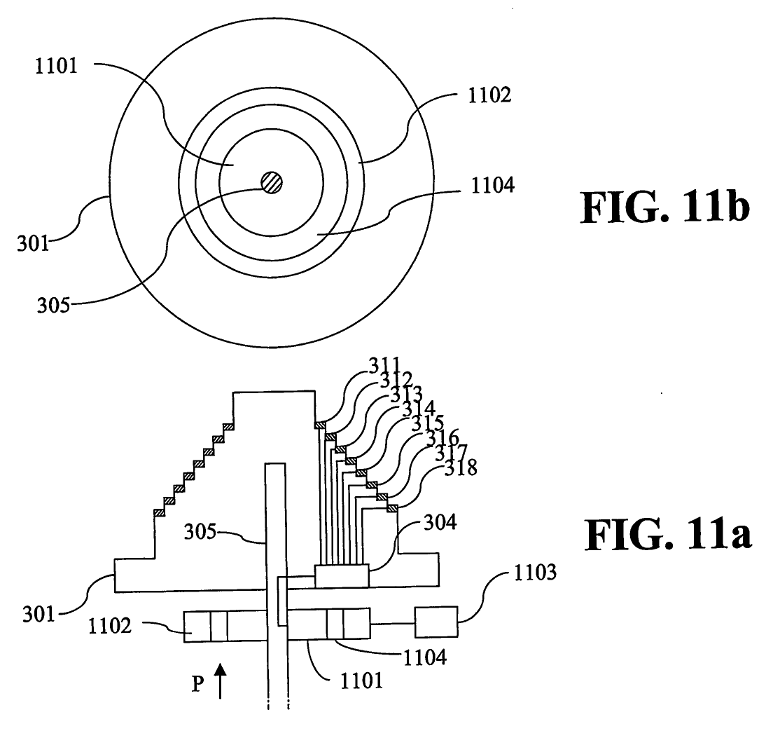

FIG. 11a shows an optical scanning device in accordance with a third embodiment of the invention. In this embodiment, the optical scanning device comprises a first conductor 1101 and a second conductor 1102 connected to a generator 1103. The first conductor 1101 is mounted on the rotation axis 305 and the second conductor 1102 is a fixed part of the optical scanning device. An insulator 1104 is placed between the first and second conductor 1101 and 1102. The insulator is, for example, air or a thin film of insulating oil. The first conductor 1101, the insulator 1104 and the second conductor 1102 form a capacitive ring. FIG. 11b is a projection in a direction D of FIG. 11a.

When a layer is selected, the generator 1103 generates a signal comprising information about the selected layer. This signal is applied at the poles of the second conductor 1102, which is arranged in such a way that a capacitive coupling occurs between the second conductor 1102 and the first conductor 1101. As a consequence, the signal is transmitted to the first conductor 1101, and thus detected by said first conductor 1101. The detected signal is then sent to the addressing means 304.

As capacitive coupling does not require any contact between the second conductor 1102 and the first conductor 1101, it is easily implemented in an optical scanning device according to the invention, which requires a signal transfer between a fixed part and a rotating part.

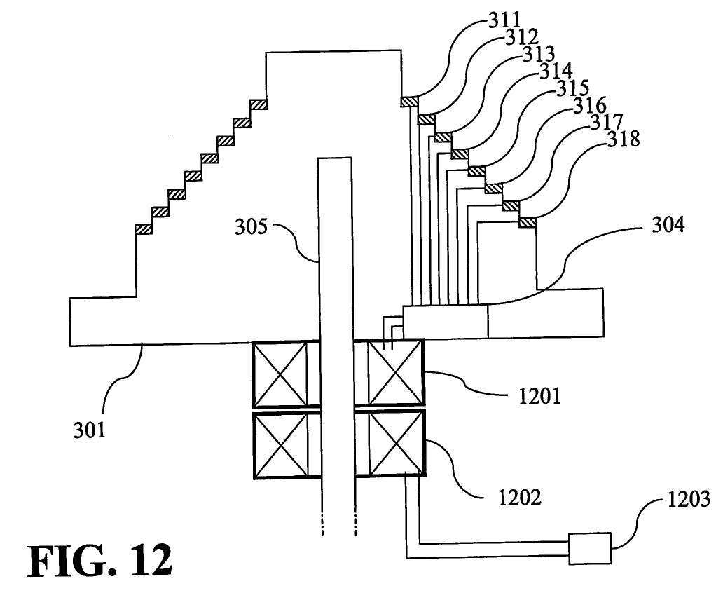

FIG. 12 shows an optical scanning device in accordance with a fourth embodiment of the invention. In this embodiment, the optical scanning device comprises an induction coil 1201 mounted on the rotation axis 305, electromagnetic means 1202 and a generator 1203. The electromagnetic means 1202 are connected to the generator 1203. The electromagnetic means 1202 and the generator 1203 form generating means, which are fixed in the optical scanning device. The generator 1203 generates a signal comprising information about the selected layer. For example, a modulated signal is generated. The electromagnetic means 1202 converts this signal into a modulated magnetic field. As a consequence, an inductive current is created in the induction coil 1201, which inductive current is modulated and corresponds to the modulated signal generated by the generator 1203. Hence, the induction coil 1201 is adapted to detect the signal generated by the generator 1203. The detected signal is then transmitted to the addressing means 304. In this embodiment, the rotation of the induction coil 1201 does not play any role, as the inductive current is created by the variation of the magnetic flux inside the induction coil 1201, which variation is due to the modulated magnetic field. As a consequence, the detected signal does not depend on the speed of rotation of the rotating part, which is an advantage.

Any reference sign in the following claims should not be construed as limiting the claim. It will be obvious that the use of the verb “to comprise” and its conjugations does not exclude the presence of any other elements besides those defined in any claim. The word “a,” or “an” preceding an element does not exclude the presence of a plurality of such elements.

1 An optical scanning device for scanning an information carrier (201) comprising a plurality of information layers which optical properties depend on a potential difference applied between two electrodes (203, 204), said optical scanning device comprising a fixed part comprising means (302) for generating a signal comprising information about a selected information layer, and a rotating part comprising means (301) for receiving said information carrier, said receiving means comprising a plurality of contacts (311-318) for connecting said electrodes, means (303) for detecting said signal, means (401) for decoding said signal and means (402, 403, 404) for applying a potential difference between the contacts connected to the electrodes corresponding to the selected information layer.

2 An optical scanning device as claimed in claim 1, wherein the means for applying a potential difference comprise a battery (403).

3 An optical scanning device as claimed in claim 1, further comprising an induction coil (501) mounted on the rotating part and means (502) for applying a magnetic flux through said induction coil in order to create an inductive current, the means for applying a potential difference being adapted to apply a potential difference corresponding to said inductive current between said two contacts.

4 An optical scanning device as claimed in claim 1, wherein the generating means are a radiation source (602) and the detecting means comprise a photosensitive detector (601).

5 An optical scanning device as claimed in claim 4, wherein the radiation source is a radiation source which is used for scanning the information carrier.

6 An optical scanning device as claimed in claim 1, wherein the detecting means comprise a conductive ring (801) and the generating means comprise a brush (802) adapted to transfer said signal to said conductive ring.

7 An optical scanning device as claimed in claim 6, wherein the conductive ring comprises a conductive fluid (1004).

8 An optical scanning device as claimed in claim 1, wherein the detecting means comprise a first conductor (1101) and the generating means comprise a second conductor (1102) adapted to transfer said signal to said first conductor by means of capacitive coupling.

9 An optical scanning device as claimed in claim 1, wherein the detecting means comprise an induction coil (1201) and the generating means comprise electromagnetic means (1202) adapted to create an inductive current inside said coil, said inductive current corresponding to said signal.

10 A method for changing optical properties of a selected information layer in an information carrier comprising a plurality of information layers which optical properties depend on a potential difference applied between two electrodes, said method comprising the steps of generating a signal comprising information about the selected information layer, detecting and decoding said signal, and applying a potential difference between the electrodes corresponding to the selected information layer.
